(19) United States
(12) Patent Application Publication
(10) Pub. No.: US 2018/0001483 A1
(43) Pub. Date: Jan. 4, 2018

(54) ROBOT SERVICE METHOD AND ROBOT APPARATUS USING SOCIAL NETWORK SERVICE

(71) Applicant: FUTURE ROBOT CO., LTD., Seongnam-si, Gyeonggi-do (KR)

(72) Inventors: Se Kyong SONG, Seongnam-si (KR); Dong Gyung KIM, Goyang-si (KR)

(73) Assignee: FUTURE ROBOT CO., LTD., Seongnam-si, Gyeonggi-do (KR)

(21) Appl. No.: 15/541,707

(22) PCT Filed: Mar. 12, 2015
(86) PCT No.: PCT/KR2015/002382

§ 371 Date: Jul. 5, 2017

(30) Foreign Application Priority Data
Jan. 5, 2015 (KR) 10-2015-0000871

(51) Int. Cl. B25J 13/00; B25J 9/16; B25J 11/00; H04L 29/08

(52) U.S. Cl. CPC B25J 13/006; B25J 11/008; B25J 9/161; B25J 11/0005; H04L 67/125

(57) ABSTRACT

The present invention relates to a robot service system and a robot apparatus using a social network service, and comprises: (a) a step in which a terminal device is connected to a robot apparatus by executing a social network service program, and displays a service screen on which an image captured by the robot apparatus is displayed; (b) a step in which the terminal device transmits a robot control command inputted to the service screen to the robot apparatus; (c) a step in which the robot apparatus performs an operation according to the robot control command and transmits operation performance data to the terminal device; and (d) a step in which the terminal device displays the operation performance data transmitted from the robot apparatus on the service screen.

### TECHNICAL FIELD

The present invention relates to a robot service method and a robot device using a social networking service (SNS), and more particularly, to a robot service method and a robot device using an SNS, by which a robot control command may be provided to the robot device using the SNS and a status of an operation corresponding to the robot control command given by a user may be checked in real time.

### BACKGROUND ART

A robot device refers to a machine capable of working autonomously. An automated robot which performs an assembly, welding, or handling process in a factory is called an industrial robot, and a robot having a function of recognizing an environment and autonomously making a decision is called an ‘intelligent robot’.

Robot devices are provided to houses and offices and used in various fields. For example, a robot device displays a received email or a message received using an instant messenger, on a display device embedded therein. The above-described robot device is called a service robot, and the service robot requires an ambient environment for a content business. In addition, the service robot is capable of interacting with users and expressing emotions, and the service robot industry will lead the future market. As lifestyles of people are individualized and family sizes are reduced, demand for housework services and emotional connection increases. As such, a life convenience product market for dual-income households or one-person households is rapidly growing. Since demand for companionship, safety, and emotional connection increases due to individualization of lifestyles and reduction in family sizes and a life convenience product market for one-person households (35% in 2035), the elderly (population over 65 will be 20% in 2020), kid care education (a birthrate of 2003 was 1.19%), and dual-income households is growing as described above, development of robot device technology capable of providing a home service is required. That is, development of a marketable home robot device based on research on robot device services suitable for lifestyles of one-person households, and emotional connection interfaces between people and robot devices is required.

### PRIOR ART DOCUMENT

(Patent Document 1) KR 1336641 entitled ‘Emotional Sympathy Robot Service System and Method of the Same’

### DISCLOSURE

### Technical Problem

Therefore, the present invention has been made in view of the above problems, and it is one object of the present invention to provide a robot service method and a robot device using a social networking service (SNS), by which a robot control command may be provided to the robot device using the SNS and a status of an operation corresponding to the robot control command given by a user may be checked in real time.

It is another object of the present invention to provide a robot service method and a robot device using a social networking service (SNS), by which home services may be provided using robot device services suitable for lifestyles of one-person households, and emotional connection interfaces between people and robot devices.

### Technical Solution

In accordance with one aspect of the present invention, provided is a robot service method using a social networking service (SNS), the method including (a) being connected to a robot device by executing an SNS program, and displaying an image captured by the robot device, on a service screen by a terminal device, (b) transmitting a robot control command input on the service screen, to the robot device by the terminal device, (c) performing an operation corresponding to the robot control command, and transmitting operation result data to the terminal device by the robot device, and (d) displaying the operation result data transmitted from the robot device, on the service screen by the terminal device.

In the method, (a) may include registering the robot device as a friend by executing the SNS program by the terminal device, being connected to the terminal device via the SNS by executing the SNS program by the robot device, transmitting the image obtained using a camera unit, to the terminal device through a service server by the robot device, and displaying the image on the service screen by the terminal device.

The service screen may include an image display window for displaying the image captured by the robot device, and a chat window for displaying input chat messages, the image display window may include an image display area for displaying the image captured by the robot device, and an adjustment key display area for displaying direction keys for moving the robot device in front, rear, left, and right directions, and the chat window may include a chat display area for displaying chat messages between users or between a user and the robot device interconnected via the SNS, a text input area for inputting text, and an additional function button for inputting the robot control command.

The robot control command may be input in a form of at least one of an emoticon, a special character, predefined code, text, and voice.

In the method, (b) may include transmitting data input on the service screen, to a service server by the terminal device, and generating a robot control command by analyzing the data, and transmitting the generated robot control command to the robot device by the service server. In the method, (c) may include performing the operation corresponding to the robot control command, and transmitting the operation result data to a service server in real time by the robot device, and transmitting the operation result data to the terminal device to display the operation result data on the service screen, by the service server.

In accordance with another aspect of the present invention, provided is a robot device including a communication unit for communicating with a terminal device or a service server to provide a social networking service (SNS), a memory for storing an SNS program, and a controller for controlling the robot device to perform an operation corresponding to a robot control command when the robot control command is received using the SNS program, and transmitting operation result data through the communication unit.

The robot control command may have a form of at least one of an emoticon, a special character, predefined code, text, and voice.

The robot device may further include a camera unit for obtaining an image, and the controller may connect the robot device to the terminal device via the SNS by executing the SNS program when the terminal device registers the robot device as a friend or when the robot control command is received, and control the robot device to display the image obtained by the camera unit, on a service screen of the SNS.

### Advantageous Effects

According to the present invention, a robot control command may be provided to a robot device using a social networking service (SNS) and a status of an operation corresponding to the robot control command given by a user may be checked in real time.

In addition, home services may be provided using robot device services suitable for lifestyles of one-person households, and emotional connection interfaces between people and robot devices.

### DESCRIPTION OF DRAWINGS

FIG. 1 is a conceptual diagram of a robot service using a social networking service (SNS), according to an embodiment of the present invention.

FIG. 2 is a schematic diagram of a robot service system using an SNS, according to an embodiment of the present invention.

FIG. 3 is a block diagram of a robot device according to an embodiment of the present invention.

FIG. 4 is a block diagram of a service server according to an embodiment of the present invention.

FIG. 5 is a flowchart of a robot service method using an SNS, according to an embodiment of the present invention.

FIG. 6 is an image of a service screen according to an embodiment of the present invention.

FIG. 7 includes screen images for describing additional function icons according to an embodiment of the present invention.

### MODE OF THE INVENTION

Details of the above-described aspects, features, and effects of the present invention will become apparent from the following detailed description of the invention, the accompanying drawings, and the appended claims.

Hereinafter, ‘a robot service method and a robot device using a social networking service (SNS)’ according to the present invention are described in detail with reference to the accompanying drawings. Embodiments described herein are provided for one of ordinary skill in the art to easily understand the technical features of the present invention, and the present invention is not limited to the embodiments. Furthermore, illustrations of the drawings are provided to easily describe the embodiments of the present invention, and may differ from actually implemented forms thereof.

Components described herein are merely examples for implementing the present invention. Accordingly, in other embodiments of the present invention, other components may be used without departing from the spirit and scope of the present invention. Furthermore, each component may be configured as only a hardware or software component, or configured as a combination of various hardware and software components for performing the same function. Alternatively, two or more components may be configured as a single hardware or software component.

It should be understood that expressions such as ‘comprises’, ‘comprising’, ‘includes’ and ‘including’ are ‘open’ expressions, and specify the presence of stated components but do not preclude the presence or addition of other components.

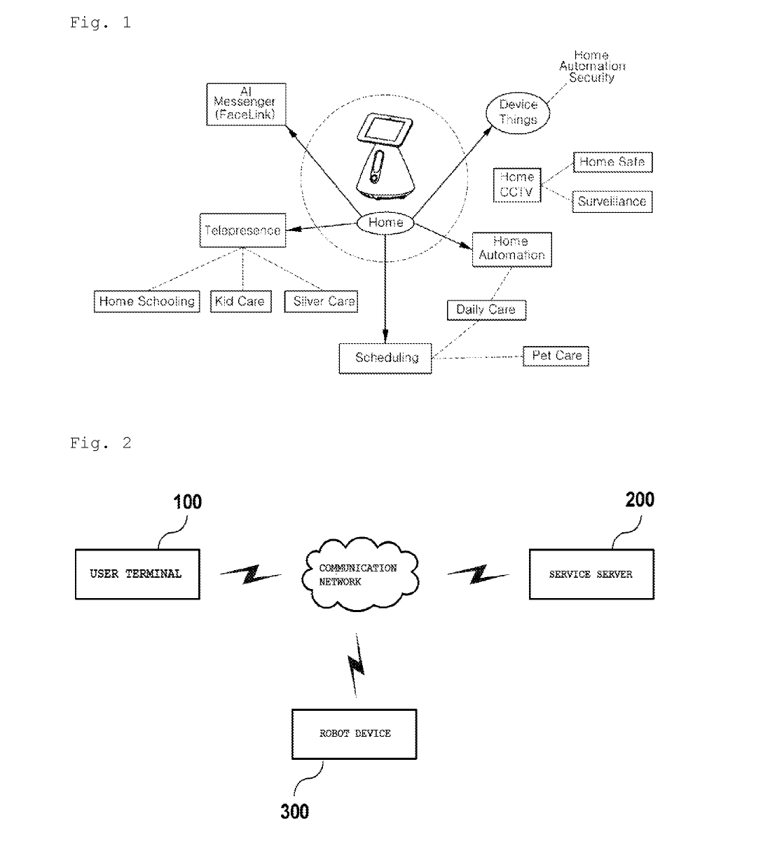

FIG. 1 is a conceptual diagram of a robot service using a social networking service (SNS), according to an embodiment of the present invention.

Referring to FIG. 1, the robot service using the SNS is a service for controlling a robot device, using the SNS.

The SNS refers to an online platform for providing free communication and information sharing among users and for generating and enhancing social relationships by making personal connections, and includes, for example, Twitter, Facebook, Kakao Talk, Line, My Space, and Cyworld.

The robot device registered in the SNS is recognized as an object corresponding to a member who participates in the SNS. The robot device performs an operation corresponding to a robot control command input by a user connected thereto via the SNS, and notifies the user of operation result data in a cycle or in real time. In this case, the robot device notifies the user of the operation result data using various methods, e.g., voice, image, and text.

Specifically, the robot device provides a telepresence service, an artificial intelligence (AI) messenger service, a scheduling service, a home automation service, a home closed-circuit television (CCTV) service, etc. among members who participate in the SNS. The telepresence service includes a home schooling service, a kid care service, an silver care service, etc. The scheduling service includes a daily care service, a pet care service, an silver care service, etc.

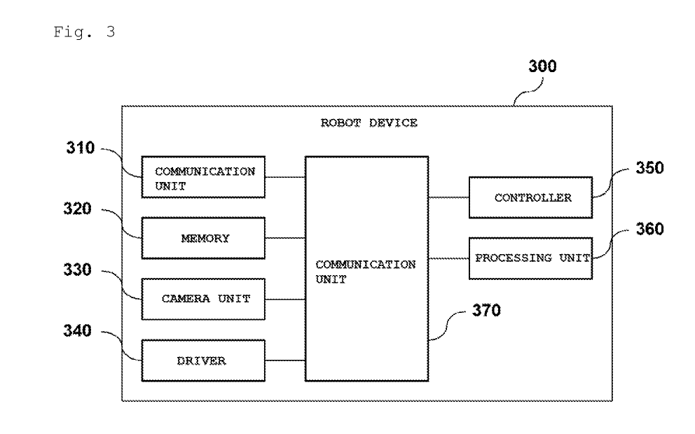

FIG. 2 is a schematic diagram of a robot service system using an SNS, according to an embodiment of the present invention.

Referring to FIG. 2, the robot service system using the SNS includes a terminal device 100, a service server 200, and a robot device 300.

The terminal device 100 transmits a robot control command to the robot device 300 using an SNS program, and displays operation result data transmitted from the robot device 300. Herein, the robot control command may be provided in the form of at least one of an emoticon, a special character, predefined code, text, and voice.

The terminal device 100 may include not only a fixed device such as a desktop computer but also a mobile device such as a personal digital assistant (PDA), a cellular phone, or a laptop computer. That is, the terminal device 100 is an electronic device including a display unit and capable of driving the SNS program.

The service server 200 is connected to the terminal device 100 and the robot device 300 through a communication network to provide a service for controlling the robot device 300, using the SNS, and stores operation names for various operations, operation codes, operation control data for performing operations corresponding to the operation codes, and emoticon image data corresponding to the operations.

The service server 200 generates a robot control command by analyzing data input by the terminal device 100 to the robot device 300, and transmits the generated robot control command to the robot device 300.

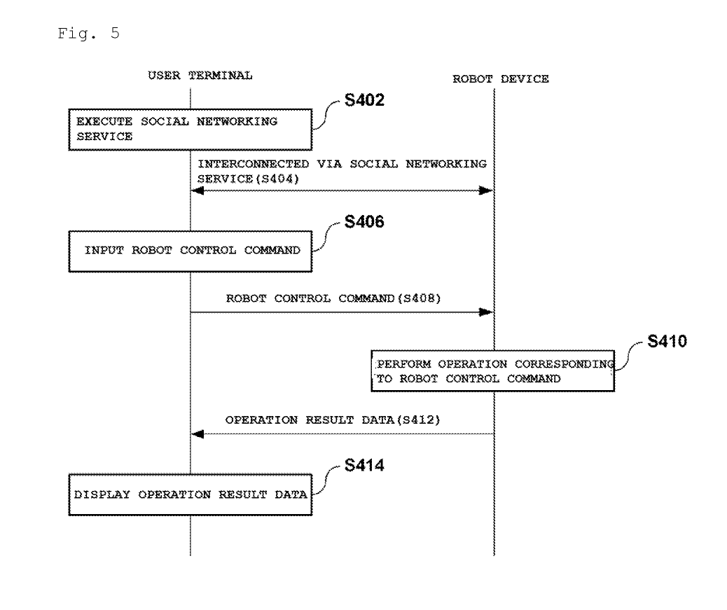

A detailed description of the service server 200 will be given below with reference to FIG. 4.

The robot device 300 performs an operation corresponding to the robot control command transmitted from the terminal device 100 or the service server 200, and transmits operation result data to the terminal device 100 to display the same on a service screen.

The robot device 300 has an account with the SNS, and is recognized as a member who participates in the SNS, using the account.

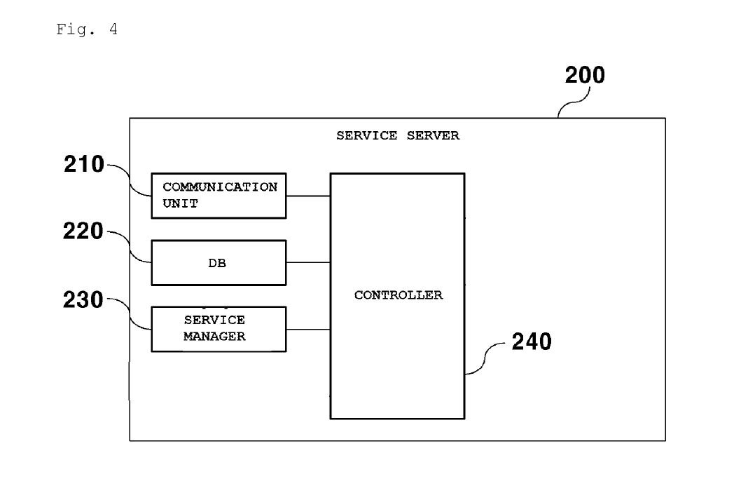

A detailed description of the robot device 300 will be given below with reference to FIG. 3.

The terminal device 100, the service server 200, and the robot device 300 are interconnected through a communication network, and the communication network refers to a network capable of transmitting and receiving data based on the Internet protocol using various wired/wireless communication technologies, e.g., the Internet, an intranet, a mobile communication network, and a satellite communication network.

FIG. 3 is a block diagram of a robot device 300 according to an embodiment of the present invention.

Referring to FIG. 3, the robot device 300 includes a communication unit 310, a memory 320, a camera unit 330, a driver 340, and a controller 350.

The communication unit 310 is a communication means for interconnecting the robot device 300 and a terminal device or the robot device 300 and a service server through a communication network, and may include, for example, a wireless communication module such as a mobile communication module or a satellite communication module, a wired communication module such as an Internet module, or a short-range wireless communication module such as a Wi-Fi module.

The memory 320 stores programs required to control operations of the robot device 300, and data generated when the programs are executed. The memory 320 may be configured to include various types of memory devices. Particularly, the memory 320 stores an SNS program.

The camera unit 330 captures images. In this case, the camera unit 330 captures the images in a preset cycle or in real time.

The driver 340 refers to hardware that operates under the control of the controller 350. For example, if the robot device 300 is a home cleaning robot, the driver 340 may include a driving motor for driving the cleaning robot and a suction motor for vacuum suction.

When a robot control command is received using the SNS program, the controller 350 controls the robot device 300 to perform an operation corresponding to the robot control command, and transmits operation result data to the service server through the communication unit 310.

That is, when a user of the terminal device registers the robot device 300 as a friend on an SNS or the robot control command is received from the terminal device, the controller 350 is connected to the terminal device by executing the SNS program stored in the memory 320. Thereafter, the controller 350 drives the camera unit 330 and controls the robot device 300 to display the images obtained by the camera unit 330, on a service screen of the SNS.

The controller 350 transmits the images captured by the camera unit 330 to the service server through the communication unit 310 in a certain cycle or in real time, to store the same in the service server. When users connected to the robot device 300 via the SNS execute the SNS program, the images stored in the service server are provided as history images about past situations. As such, the users may check all of the past situations of a certain place (e.g., home).

In addition, when schedule reservation information for silver care, pet care, or daily care is set, the controller 350 performs an operation corresponding to the schedule reservation information at a set time, and provides operation result data to the terminal device through the service server. For example, when ‘Grandmother's medicine time: 12:00 PM’ is set as the schedule reservation information, if it is 12:00 PM, the controller 350 outputs voice saying ‘Grandmother, it's time to take your medicine.’, drives the camera unit 330 to capture an image of grandmother taking her medicine, and transmits the image to the service server.

The controller 350 controls operations of the communication unit 310, the memory 320, the camera unit 330, and the driver 340.

The controller 350 may include at least one computing device. In this case, the computing device may include a central processing unit (CPU) which is broadly used, a programmable device configured appropriately for a certain purpose (e.g., a complex programmable logic device (CPLD) or a field-programmable gate array (FPGA)), an on-demand semiconductor computing device (e.g., an application-specific integrated circuit (ASIC)), or a microcontroller chip.

FIG. 4 is a block diagram of a service server 200 according to an embodiment of the present invention.

Referring to FIG. 4, the service server 200 includes a communication unit 210, a database 220, a service manager 230, and a controller 240.

The communication unit 210 is a communication means for interconnecting the service server 200 and a terminal device or the service server 200 and a robot device through a communication network, and may include, for example, a wireless communication module such as a mobile communication module or a satellite communication module, a wired communication module such as an Internet module, or a short-range wireless communication module such as a Wi-Fi module.

The database 220 stores information about users or robot devices having accounts with an SNS.

The database 220 stores identification information of users (including robot devices) who currently participate in the SNS, chat messages, robot control commands, images previously captured by the robot devices, images transmitted from the robot devices in real time, etc.

The database 220 further stores information about emoticons, special characters, text, icons, codes, voices, and special codes corresponding to the robot control commands.

When images (including still and moving images) captured by a robot device which does not currently execute the SNS program are received, the service manager 230 stores the images in the database 220 and provides the images, which are stored in the database 220, as history images about past situations when users connected to the robot device via the SNS execute the SNS program. As such, the users may check all of the past situations of a certain place (e.g., home).

In addition, when data input by the terminal device to the robot device is received, the service manager 230 generates a robot control command by analyzing the data, and transmits the generated robot control command to the robot device. For example, if the data transmitted from the terminal device is an emoticon, the service manager 230 finds a robot control command corresponding to the emoticon, in the database 220, and transmits the robot control command to the robot device. Otherwise, if the data transmitted from the terminal device is text, the service manager 230 analyzes the text to extract text corresponding to a robot control command, finds a robot control command corresponding to the text, in the database 220, and transmits the robot control command to the robot device.

The controller 240 controls operations of the communication unit 210, the database 220, and the service manager 230.

The controller 240 may include at least one computing device. In this case, the computing device may include a CPU which is broadly used, a programmable device configured appropriately for a certain purpose (e.g., a CPLD or an FPGA), an on-demand semiconductor computing device (e.g., an ASIC), or a microcontroller chip.

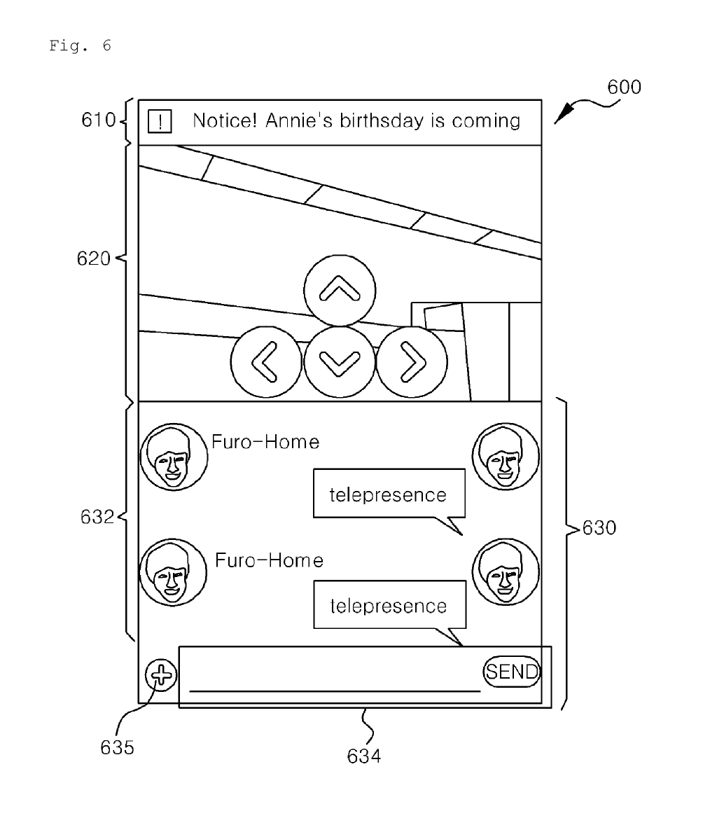

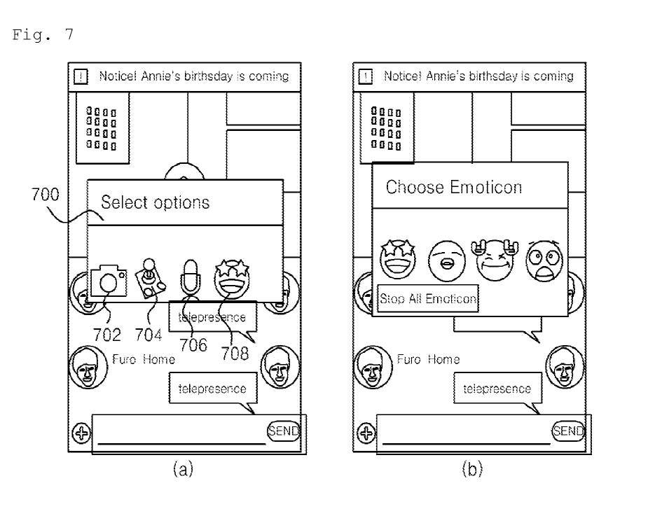

FIG. 5 is a flowchart of a robot service method using an SNS, according to an embodiment of the present invention. FIG. 6 is an image of a service screen according to an embodiment of the present invention. FIG. 7 includes screen images for describing additional function icons according to an embodiment of the present invention.

Referring to FIG. 5, when an SNS program is executed (S402), a terminal device and a robot device are interconnected via an SNS (S404).

That is, when the terminal device executes the pre-stored SNS program and registers the robot device as a friend, the robot device executes the SNS program. As such, the terminal device and the robot device are interconnected via the SNS. The terminal device and the robot device may be interconnected using an Internet-based system or a short-range wireless communication system.

When the terminal device and the robot device are interconnected via the SNS, if a user of the terminal device inputs a robot control command on a service screen (S406), the terminal device transmits the input robot control command to the robot device (S408). In this case, the user of the terminal device may input the robot control command in various forms such as an emoticon, a special character, a predefined code, text, and voice.

That is, when the terminal device and the robot device are interconnected via the SNS, the terminal device includes a service screen 600 illustrated in FIG. 6. The service screen 600 includes a notification window 610 for displaying family events, etc., an image display window 620 for displaying an image captured by the robot device, and a chat window 630 for displaying input chat messages.

The image display window 620 includes an image display area for displaying the image captured by the robot device, and an adjustment key display area 625 for displaying direction keys for moving the robot device in front, rear, left, and right directions. The user connected to the robot device via the SNS may move the robot device in front, rear, left, and right directions using the direction keys displayed on the adjustment key display area 625 of the service screen 600, and the image captured by the robot device varies due to motion of the robot device.

The chat window 630 includes a chat display area 632 for displaying chat messages between users or between a user and the robot device interconnected via the SNS, a text input area 634 for inputting text, and an additional function button 635 for providing additional functions.

The user connected to the robot device via the SNS may input text on the text input area 634 as a robot control command. In this case, the terminal device analyzes the input text to extract text corresponding to a robot control command, generates the extracted text as a robot control command, and transmits the robot control command to the robot device through a service server. If the terminal device transmits the input text to the service server, the service server analyzes the text to extract text corresponding to a robot control command, generates the extracted text as a robot control command, and transmits the robot control command to the robot device. Otherwise, if the terminal device transmits the input text to the robot device through the service server, the robot device analyzes the text to extract text corresponding to a robot control command, and generates the extracted text as a robot control command.

When the additional function button 635 is pressed, additional function icons illustrated in FIG. 7(a) are displayed. In this case, an additional function window 700 including the additional function icons may be displayed in an overlay mode or a slide mode. The additional function icons may include a camera icon 702, a remote control icon 704, a microphone icon 706, an emoticon icon 708, etc. The camera icon 702 is an icon for providing a function of taking a photo using a camera unit of the robot device and displaying the photo on the SNS. When the user selects the camera icon 702 and transmits a selection signal to the robot device, the robot device takes a photo and transmits the photo to be displayed on the SNS. The remote control icon 704 is an icon for providing a function of remotely controlling the robot device, and the user may remotely control the robot device by selecting the remote control icon 704. The microphone icon 706 is an icon for inputting voice as a robot control command, and the user may input voice as a robot control command by selecting the microphone icon 706. The emoticon icon 708 is an icon for sending an emoticon to the robot device. When the user selects the emoticon icon 708, emoticons illustrated in FIG. 7(b) are displayed. If one of the emoticons is selected and transmitted to the robot device, the robot device performs an operation corresponding to the emoticon. For example, if the user selects and transmits a ‘laughing’ emoticon to the robot device, the robot device laughs.

Data corresponding to the robot control command input on the chat window of the service screen in the form of at least one of an emoticon, a special character, predefined code, text, and voice is transmitted to the service server. The service server generates a robot control command by analyzing the data transmitted from the terminal device, and transmits the generated robot control command to the robot device.

The robot device having received the robot control command performs an operation corresponding to the robot control command (S410), and transmits operation result data to the terminal device through the service server (S412). In this case, the robot device transmits the operation result data to the terminal device through the service server in real time, and the service server transmits the operation result data to the terminal device to display the operation result data on the image display window.

The terminal device displays the operation result data transmitted from the robot device, on the service screen (S414). As such, the user of the terminal device may check an operation status of the robot device in real time.

The above-described robot service method using the SNS can be written as a program, and codes and code segments of the program can be easily construed by programmers of ordinary skill in the art. The program for executing the robot service method using the SNS can be stored in electronic-device-readable media, and can be read and executed by electronic devices.

While the present invention has been particularly shown and described with reference to embodiments thereof, it will be understood by one of ordinary skill in the art that various changes in form and details may be made therein without departing from the spirit and scope of the invention as defined by the following claims. The embodiments should be considered in a descriptive sense only and not for purposes of limitation. Therefore, the scope of the invention is defined not by the detailed description of the invention but by the following claims, and all differences within the scope will be construed as being included in the present invention.

### EXPLANATION OF REFERENCE NUMERALS

100: terminal device 200: service server
210, 310: communication unit 220: database
230: service manager 240, 350: controller
300: robot device 320: memory
330: camera unit 340: driver

1. A robot service method using a social networking service (SNS), the method comprising:
(a) being connected to a robot device by executing an SNS program, and displaying an image captured by the robot device, on a service screen by a terminal device;
(b) transmitting a robot control command input on the service screen, to the robot device by the terminal device;
(c) performing an operation corresponding to the robot control command, and transmitting operation result data to the terminal device by the robot device; and
(d) displaying the operation result data transmitted from the robot device, on the service screen by the terminal device.

2. The method according to claim 1, wherein (a) comprises:
registering the robot device as a friend by executing the SNS program by the terminal device;
being connected to the terminal device via the SNS by executing the SNS program by the robot device;
transmitting the image obtained using a camera unit, to the terminal device through a service server by the robot device; and
displaying the image on the service screen by the terminal device.

3. The method according to claim 1, wherein the service screen comprises an image display window for displaying the image captured by the robot device, and a chat window for displaying input chat messages,
wherein the image display window comprises an image display area for displaying the image captured by the robot device, and an adjustment key display area for displaying direction keys for moving the robot device in front, rear, left, and right directions, and
wherein the chat window comprises a chat display area for displaying chat messages between users or between a user and the robot device interconnected via the SNS, a text input area for inputting text, and an additional function button for inputting the robot control command.

4. The method according to claim 1, wherein the robot control command is input in a form of at least one of an emoticon, a special character, predefined code, text, and voice.

5. The method according to claim 1, wherein (b) comprises:
transmitting data input on the service screen, to a service server by the terminal device; and
generating a robot control command by analyzing the data, and transmitting the generated robot control command to the robot device by the service server.

6. The method according to claim 1, wherein (c) comprises:
performing the operation corresponding to the robot control command, and transmitting the operation result data to a service server in real time by the robot device; and
transmitting the operation result data to the terminal device to display the operation result data on the service screen, by the service server.

7. A robot device comprising:
a communication unit for communicating with a terminal device or a service server to provide a social networking service (SNS);
a memory for storing an SNS program; and
a controller for controlling the robot device to perform an operation corresponding to a robot control command when the robot control command is received using the SNS program, and transmitting operation result data through the communication unit.

8. The robot device according to claim 7, wherein the robot control command has a form of at least one of an emoticon, a special character, predefined code, text, and voice.

9. The robot device according to claim 7, further comprising a camera unit for obtaining an image,
wherein the controller connects the robot device to the terminal device via the SNS by executing the SNS program when the terminal device registers the robot device as a friend or when the robot control command is received, and controls the robot device to display the image obtained by the camera unit, on a service screen of the SNS.
